(19) United States
(12) Patent Application Publication
(10) Pub. No.: US 2012/0066911 A1
(43) Pub. Date: Mar. 22, 2012

(54) INFANT FEEDING SPOON WITH ATTACHMENTS FOR DISPENSING FOOD

(76) Inventor: Robert Edward Hicks, Deale, MD (US)

(21) Appl. No.: 12/888,334

(22) Filed: Sep. 22, 2010

(51) Int. Cl. A47G 21/04; A47J 43/28

(52) U.S. Cl. 30/141; 222/39; 222/156

(57) ABSTRACT

An infant feeding device, including a reservoir section, including a viewing window and a cylindrical gear ratchet for metering delivery of a food product into an infant's mouth; a rubber piston mounted on a handle configured to engage with the reservoir section so that when operated the rubber piston and the reservoir section operate to take in or expel the food product via an opening in an attachment end of the reservoir section; and an attachment arm removably coupled to the attachment end of the reservoir section for removably securing a plurality of attachment ends thereto.

### BACKGROUND OF THE INVENTION

1. Field of the Invention

The present invention generally relates to infant feeding device and more particularly to an infant feeding spoon, including a plurality of interchangeable attachment ends, and designed to make infant feeding cleaner and easier.

2. Discussion of the Background

Over the years, various types of self filling spoons have been developed for administering medicine or food products but have failed to make it into the marketplace. For example, U.S. Pat. No. 6,675,482 to Gilbert, U.S. Pat. No. 2,698,996 to Hickerson, and U.S. Pat. No. 5,377,879 to Isaacs are devices for dispensing a metered amount of food or medicine into a spoon. However, such devices are not designed to deliver food once the device is in the child's mouth and once the piston is activated. Therefore, these devices are not effective in keeping a child from grabbing the food product in the exposed spoon end.

### SUMMARY OF THE INVENTION

Therefore, there is a need for a device that overcomes the deficiencies in the background art devices and that is configured for dispensing liquid solid food into a child's mouth, that is simple to manufacture, and that is effective for delivering food products once the device is in the child's mouth, and without making a mess.

The above and other needs are addressed by embodiments of the present invention, which include a device having a handle chamber with a variety of spoon, fork, nipple, and the like, shaped attachments with one or more integral orifices to take in and expel liquid solid foods. The handle chamber of the device includes a piston pump ring having a plunger that fits tightly in the reservoir tube. The plunger handle end of the device can be pulled along inside a cylindrical reservoir to take in baby food products and then pushed in measured increments to expel the food directly into the infant's mouth during feeding via the one or more orifices provided in the ends of the attachments. The spoon or nipple shaped attachment ends are detachable and contain an integral orifice near the front of the vessel which when inserted becomes sufficiently contained in the child's mouth. A variety of attachments are provided, for example, including one in the shape similar to that of a bottle nipple end to aid in the transition training between bottle and spoon feeding, and attachments in the shapes of spoons, forks, and the like. In an exemplary embodiment, there is provided a raised gear rack in the reservoir that turns the piston into a ratchet that meters the food with perceivable audible click as the handle is pushed deeper into the reservoir.

Accordingly, in an exemplary aspect there is provided an infant feeding device, including a reservoir section, including a viewing window and a cylindrical gear ratchet for metering delivery of a food product into an infant's mouth; a rubber piston mounted on a handle configured to engage with the reservoir section so that when operated the rubber piston and the reservoir section operate to take in or expel the food product via an opening in an attachment end of the reservoir section; and an attachment arm removably coupled to the attachment end of the reservoir section for removably securing a plurality of attachment ends thereto.

The device can include a plurality of attachment ends having an orifice at an end thereof and that are configured to be removably secured to the attachment arm.

The attachment ends can be configured in a plurality of shapes and sizes for delivery of the food product via the orifice by operation of the rubber piston engaged with the reservoir section.

The rubber piston can include a ring configured to come into contact with cylindrical raised gear teeth disposed inside the reservoir section, such that when the ring meets the raised gear teeth, the ring snaps past the raised gear teeth producing an audible and perceivable clicking sound.

Still other aspects, features, and advantages of the present invention are readily apparent from the following detailed description, simply by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary baby feeding device in its operative position with two variations of the feeding attachments in profile view;

FIG. 2 illustrates an exemplary baby feeding device in its component position with multiple variations in of the attachment ends in profile view; and

FIGS. 3A-3B illustrate cut away and three dimensional views of an exemplary gear rack and ratchet of the device of FIGS. 1-2.

### DETAILED DESCRIPTION OF THE PREFERRED EMBODIMENTS

The exemplary device and individual components thereof are configured for feeding an infant child, advantageously, without the baby's hands coming in contact with the food product. The feeding of an infant without the baby's hands coming in contact with the food product occurs when the food is expelled from a reservoir tube through an orifice integral to an attachment end of the device when the orifice is sufficiently in the child's mouth. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention. The pieces comprising the device can be produced of a sufficiently strong, medical/food grade plastic, and the like, for example, that can resist being brought to sterilization temperatures a large number of times without significantly deteriorating.

Generally, the present disclosure is directed to a device for feeding an infant child its first solid food without waste or making a mess of the infants' hands, face, clothing, and the like. The present invention includes recognition that when trying to feed an infant child solid food, the child's first instinct is to touch the food to investigate it. Once the food is on the child's hands there is no limit to the immediate mess that can be made when the child transfers the food from their hands to everything that is touched. Typically, a child transitions from a bottle and nipple at the age of about seven months. Introduction of the child to a spoon at this time provides a challenge because of the child's reflex to grab the food product in the exposed spoon end. Advantageously, the exemplary device prevents a child from making a mess while exploring the device, for example, configured as an empty spoon, and which is presented without coming into contact with the food product prior to activation. The spoon device can be filled with food once in the infant's mouth and out of the range of the infant's hands, so as to transfer food products to the infant in a clean and reliable manner.

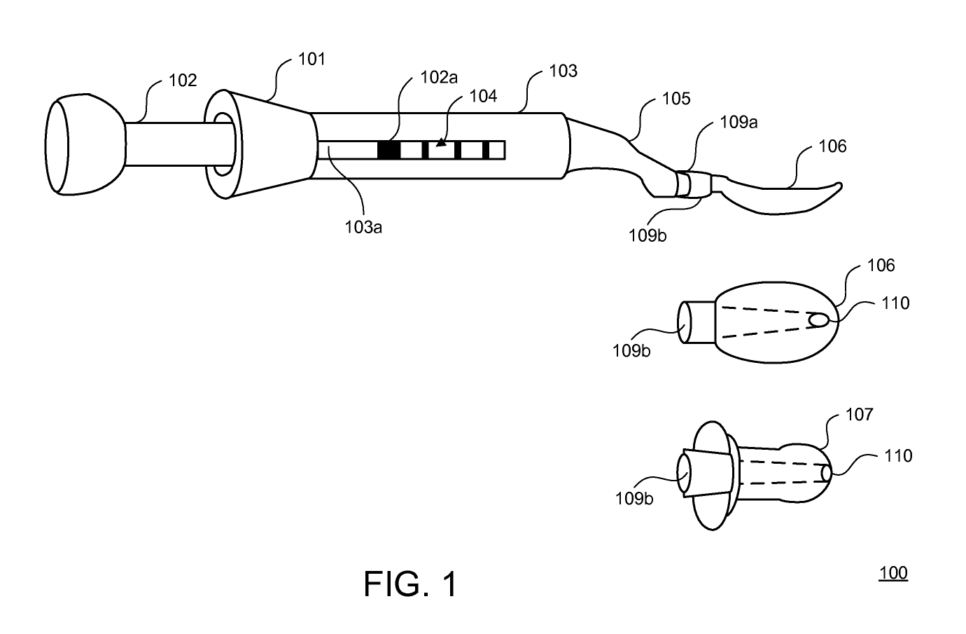

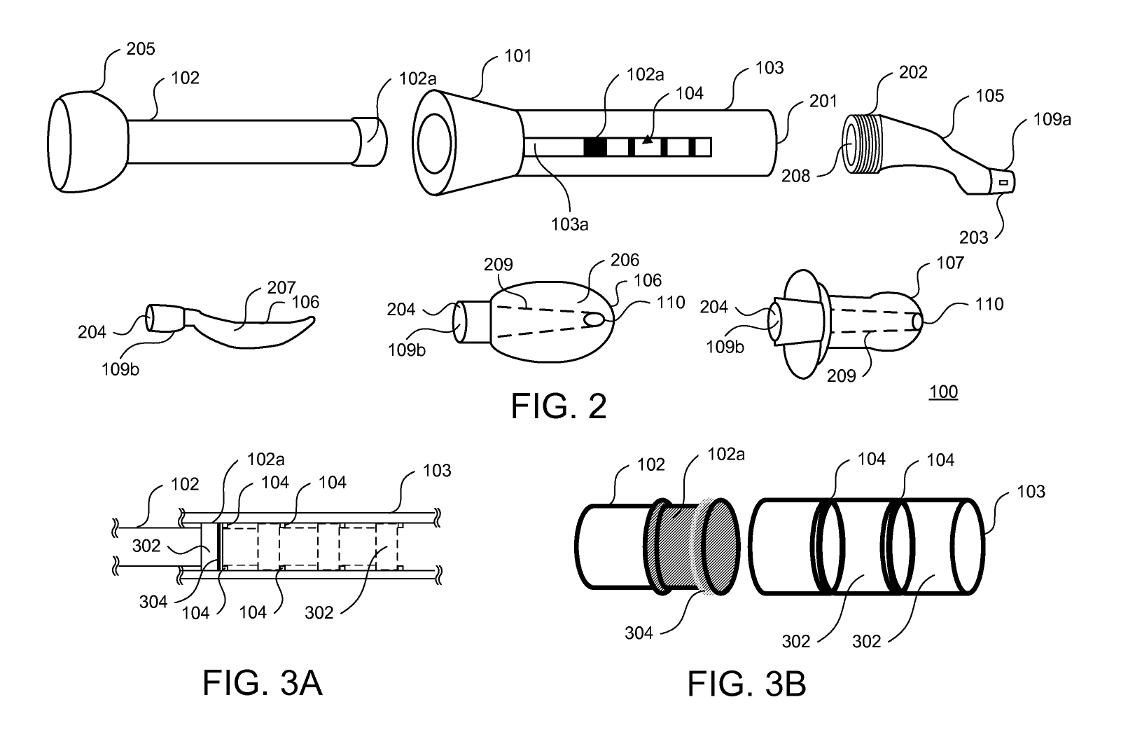

Referring now to the drawings, wherein like reference numerals designate identical or corresponding parts throughout the several views, and more particularly to FIGS. 1-2 thereof, there is illustrated a baby feeding device 100, and components thereof, according to the present disclosure. In FIG. 1, the exemplary device 100 includes multiple components 101-107 that perform various functions. A hollow reservoir handle 103 having a base 101 and a clear plastic window 103a is provided for performing a multitude of functions. An operating handle 102 is provided and includes a rubber piston plunger 102a (e.g., made of rubber material, etc.) attached to an end thereof. The operating handle 102 member slides snugly into the reservoir handle 103 on one end creating a vacuum therein. A cylindrical gear rack and ratchet 104 are provided internal to the reservoir 103. The cylindrical gear rack and ratchet 104, advantageously, provides resistance and meters food with an audible click when the piston end 102a moves through the reservoir 103.

Hollow interchangeable attachment ends 106-107 are provided and configured in various shapes (e.g., spoon shapes, nipple shapes, fork shapes, etc.) and sizes so as to perform a variety of functions. The attachment ends 106-107 include integral mechanical connectors 109b, which engage with corresponding connectors 109a of a hollow attachment arm 105 (e.g., via threads, pressure fits, etc.), so that the attachment ends 106-107 can be removable attached and securely into place onto the attachment arm 105 of the reservoir handle 103. Advantageously, a multitude of food types can be introduced into the reservoir 103 when integrated orifices 110 of the attachment ends 106-107 are placed directly into the food product source and the operating handle 102 and piston 102a are pulled back. In a similar manner, food can be introduced into the reservoir 103 with the attachment ends 106-107 removed or food product also can be introduced at the base end 101 of the reservoir handle 103. Accordingly, the operating handle 102 and piston 102a can be pulled out to the end of the rubber piston plunger 102a for filling with food products. Food products entering and exiting the reservoir 103 can be viewed as they are received or expelled via the viewing window 103a and while being metered by the cylindrical gear rack 104.

The hollow attachment ends 106-107 expel food product when the handle chamber 102 and piston end 102a move inside the reservoir 103 toward the base of hollow attachment arm 105. The piston 102a travels along the reservoir 103 encountering the gear ratchets 104, which are configured to present discernable resistance and audible clicks, and meter food products through the hollow attachment arm 105. Every gradient of the gear rack 104 can be spaced such that the device 100 expels a predetermined, metered amount of food product through the orifices 110 of the hollow attachment ends 106-107. After the feeding is complete, the parts 101-107 of the device 100 can be easily disassemble for cleaning by any suitable dishwashing method, and the like.

In FIG. 2, the individual components 101-107 of the device 100 are shown in further detail and in a disassembled state and can be made of any suitable materials, such as plastic, metal, rubber, wood, and the like, but can be commonly constructed of sufficiently strong industrialized food grade plastics, rubbers, and the like. A threaded end 201 of the reservoir chamber 103 accepts a corresponding threaded base 202 of the hollow attachment arm 105 having channel 208 corresponding to channel 209 of the feeding attachments 106-107. An end 203 of the attachment arm 105 removably locks in a mechanical manner (e.g., via a snap fit, threads, etc.) onto corresponding ends 204 of the feeding attachments 106-107. A base 205 of the piston handle 102 can be made so as to be of an adequate size and shape so as to be operated with one hand. Advantageously, the handle 102 when inserted in the reservoir 103 provides positive feedback to the user's hand, as the piston 102a tracks across the cylindrical gear racks 104. The attachment end 107 is shown as being similar in shape and size as that of a bottle feeding nipple and embodies such a shape, advantageously, to eliminate the risk of aspiration, and like. The spoon-shaped attachment end 106 can include the orifice 110 located toward a tip portion 206 of a concave portion 207 of the spoon-shaped attachment end 106.

FIGS. 3A-3B illustrate cut away and three dimensional views of the exemplary gear rack and ratchet 104 of the device 100 of FIGS. 1-2. In FIG. 3, as the handle chamber 102 and piston end 102a move inside the reservoir 103, the piston 102a travels along the reservoir 103 encountering the gear ratchets 104, which are configured to present discernable resistance and audible clicks, and meter food products. Every gradient 302 of the gear rack 104 can be spaced such that the device 100 expels a predetermined, metered amount of food product. A small ring 304 (e.g., made of plastic, etc.) fits over the rubber piston 102a. The ring 304 comes into contact with the cylindrical gear teeth 104 (e.g., made of plastic, etc.) inside the reservoir 103. When the ring 304 meets the raised gear teeth 104, the ring 304 snaps past the raised gear teeth 104, advantageously, producing an audible and perceivable clicking sound, and the like.

Although the device 100 and components thereof, as described in FIGS. 1-3, are illustrated in terms of being of certain shapes, the device 100 and components thereof can be configured in any suitable shapes, such that the assembled components, for example, can resemble all suitable variations of animals, flying machines, automobiles, boats, and the like, as will be appreciated by those of ordinary skill in the infant product arts.

Thus, described herein is an improved infant feeding device for feeding an infant child first solid food without the issue of the food getting on the infant's hands, face, and clothing or the wasting of food during the process of feeding. The exemplary infant feeding device with its multiple attachment ends, advantageously, can take in and expel food product through the clear plastic orifice end. The plunger handle with the piston end of the device can be pulled along inside the cylindrical reservoir to take in liquid or solid food, and the like, and then can be pushed in to expel the food directly into the infant's mouth. The gear rack and ratchet meter the food with a physical stop and audible click when the handle ends moves the piston through the reservoir. The reservoir can be configured for containing a metered amount of food product. The clear window in the reservoir can be configured for viewing the food product therewithin. The set of attachment ends with orifices are suitable for the safe and sufficient insertion into an infant's mouth during feeding. The components of the device can be easily disassembled for cleaning, and the like.

While the present invention has been described in connection with a number of exemplary embodiments and implementations, the present invention is not so limited but rather covers various modifications and equivalent arrangements, which fall within the purview of the appended claims.

What is claimed is:

1. An infant feeding device, comprising:
a reservoir section, including a viewing window and a cylindrical gear ratchet for metering delivery of a food product into an infant's mouth;
a rubber piston mounted on a handle configured to engage with the reservoir section so that when operated the rubber piston and the reservoir section operate to take in or expel the food product via an opening in an attachment end of the reservoir section; and
an attachment arm removably coupled to the attachment end of the reservoir section for removably securing a plurality of attachment ends thereto.

2. The device of claim 1, further comprising:
a plurality of attachment ends having an orifice at an end thereof and that are configured to be removably secured to the attachment arm.

3. The device of claim 2, wherein the attachment ends are configured in a plurality of shapes and sizes for delivery of the food product via the orifice by operation of the rubber piston engaged with the reservoir section.

4. The device of claim 1, wherein the rubber piston includes a ring configured to come into contact with cylindrical raised gear teeth disposed inside the reservoir section, such that when the ring meets the raised gear teeth, the ring snaps past the raised gear teeth producing an audible and perceivable clicking sound.
